(19) United States
(12) Patent Application Publication
(10) Pub. No.: US 2006/0089935 A1
(43) Pub. Date: Apr. 27, 2006

(54) Failover and load balancing for server clusters

(75) Inventors: David Clifford, Santa Clara, CA (US); Dominic J. Angelini, San Jose, CA (US); Dustin L. Green, Redmond, WA (US); Geoffrey Smith, Mountain View, CA (US); Peter T. Barrett, San Francisco, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/973,140

(22) Filed: Oct. 26, 2004

(51) Int. Cl. G06F 17/30

(52) U.S. Cl. 707/10

(57) ABSTRACT

Failover and load balancing in a server cluster is described. In an implementation, a method includes receiving a plurality of requests from a plurality of clients, wherein each said request is for accessing a service provided by a plurality of servers arranged in a server cluster. A partial service map is generated for each of the clients such that each of the partial service maps reference a subset of the plurality of servers.

### TECHNICAL FIELD

The present invention generally relates to the field of server clusters and more particularly relates to failover and load balancing for server clusters.

### BACKGROUND

Content providers continue to offer an ever increasing array of content to users. For example, a user may view traditional television programming received over a broadcast network by using a client, such as a set-top box. The user may also view pay-per-view movies, order video-on-demand (VOD) content, interact with video games, and so on.

To provide this array of content, a variety of new and pre-existing systems may be employed by the television content providers. A multiple systems operator (MSO), for instance, may include a plurality of head ends to broadcast traditional television programming. Each head end may include a plurality of servers arranged in a “cluster”, which is commonly referred to as a “server cluster”. The server cluster may appear as a single system to a client that accesses the server cluster to obtain content maintained for distribution to the client. For example, a client configured as a set-top box may access the server cluster to obtain a television program, a radio program, a movie, and so on, which is streamed from the server cluster to the client. As previously described, however, a wide variety of content may be available to the client such that each server in the cluster is not configured to provide each content item. Therefore, to obtain a particular content item, the client is directed to a server which provides a desired content item.

A variety of approaches may be utilized to direct the client to the desired content item. One traditional approach involves providing the client with a complete map which describes each server of the cluster and each content item that is available from the server. Therefore, utilizing this approach, the client may make its own decisions regarding how and where to obtain a desired content item. However, this approach may result in the transfer of large amounts of data to describe each location at which the content may be accessed thereby resulting in inefficient use of server, network, and client resources to create, communicate, and store the complete map. Additionally, the server cluster in this approach does not exercise control over individual clients, and therefore is not able to “load balance” the requests made by the clients, which may result in excessive use a particular server even though another server in the cluster is not being utilized.

In another traditional approach, the client communicates with a dedicated server in the server cluster, which is utilized to direct the client to the particular server which provides the particular content item. For instance, the dedicated server may be configured to assign individual clients to a particular server each time a new content item was requested. Therefore, if an application requires specific load-balancing and management of each connection request, this other approach may be utilized to provide such management. However, this other approach may also result in inefficient use of the server, network and client resources in some instances, such as if this level of control is not necessary. For instance, in this approach the client must communicate with the dedicated server each time it desires access to a content item before it can actually access the desired content item. Therefore, if such management is not needed, the additional communications may result in inefficiencies. Also, in the case of server failure, the client must reconnect to the dedicated server to discover another server which also provides the desired content item. Further, in the case that the load-balancing server itself fails, clients are unable to connect to any service for the duration of the failure.

Therefore, there is a continuing need to improve techniques for failover and load balancing of server clusters.

### SUMMARY

Failover and load balancing in a server cluster is described. In an implementation, a server cluster includes at least one “controller server”. The controller server is configured to act as an “authority” in the server cluster for determining which services are available from which servers, which services are available to stream content items to which clients, and so on. The controller server may deliver to the client, when the client originally connects to the server cluster, a subset of the complete map that describes each server/service combination that is available to stream content items to clients. In an implementation, the subset, which may referred to as a “partial service map”, contains a complete list of available content items for the client, as well as two or more servers which provide the content items. Therefore, when the client desires to access a particular content item, it selects one of the servers associated with that content item arbitrarily from the partial service map. If that server is unavailable (e.g., nonfunctioning, unreachable over a network, and so on), the client selects one of the remaining servers associated with that content item. If all servers are attempted without success, the client may reconnect to the controller server and request a new partial service map and inform the controller server which servers are unavailable. Thus, the partial service map may be utilized for automatic failover by the client. A similar technique may be employed for handling the failure of a server when the client is already connected.

Further, in an implementation, by carefully selecting which servers are published for individual clients, the controller is able to maintain a usage balance across the server cluster thereby “load balancing” the access of the server cluster by the clients. In another implementation, the client, when connecting, may request information regarding a particular service or group of services, and may cache information for those particular services over time. Therefore, in this implementation, the client may specify particular services of interest. For example, in a scenario in which a particular customer has a history of interacting with particular services, a partial service map referencing locations of just those services may be provided.

### BRIEF DESCRIPTION OF THE DRAWINGS

FIG. 1 is an illustration of an environment in an exemplary implementation that includes a plurality of distribution servers and a controller server arranged in a server cluster that is communicatively coupled to a plurality of clients over a network.

FIG. 2 is an illustration of a system in an exemplary implementation that includes the plurality of clients, the controller server, and the plurality of distribution servers and respective services of FIG. 1.

FIG. 3 is a flow diagram depicting a procedure in an exemplary implementation in which a partial service map is generated for a client based on the services that are available to the client.

FIG. 4 is a flow diagram depicting a procedure in an exemplary implementation in which a plurality of partial service maps are provided to a plurality of clients which request access to services in a service cluster.

FIG. 5 is a flow diagram depicting a procedure in an exemplary implementation in which selection of entries for inclusion in a map to be communicated to a client is described.

FIG. 6 is a flow diagram depicting a procedure in an exemplary implementation in which the partial service map that was generated in the procedure of FIG. 5 is utilized by a client to access a service utilizing failover techniques.

FIG. 7 is a flow diagram depicting a procedure in an exemplary implementation in which a change to a topology of a server cluster is passively propagated to a plurality of clients that are affected by the change.

The same reference numbers are utilized in instances in the discussion to reference like structures and components.

### DETAILED DESCRIPTION

### Overview

Failover and load balancing for server clusters is described. As previously described, server clusters may be configured to provide a wide variety of content to a user, such as television programs, movies, radio programs, and so on. However, because of the wide variety of content and amount of content, each server in the cluster may be configured to provide a subset of the total available content. Therefore, a client which desires to access to a particular content item must be directed to one or more of the servers which provide that particular content item.

To direct the client, for instance, a partial service map is provided which describes services which are executable to provide the content item, such as stream the content item over the network. For example, a user may wish to receive a television program at a set-top box. The set-top box selects a server referenced in a partial service map as providing a service which is executable to stream the particular television program. If the server is not available, the set-top box may select another server referenced in the partial service map and attempt a connection. In this way, the client is provided with failover functionality by being made “aware” of alternative servers which may provide the service. If none of the servers referenced by the partial service map are available, the client may obtain another partial service map which describes other servers which provide the particular service. Thus, the partial service map may reference services and servers from which the services are provided without referencing each possible service/server combination, thereby conserving network, server and client resources.

The partial service maps may also be configured to load balance the use of the servers of the server cluster by the clients. By selecting which servers are published via the partial service maps to respective clients, the partial service maps may be used to maintain a usage balance across the server cluster. For example, first and second clients may desire access to the same television program, which is available from a plurality of servers “A”, “B”, “C”, and “D”. A first partial service map may be generated for the first client which references servers “A” and “B”. A second partial service map, however, may be generated for the second client that references servers “C” and “D”. Thus, usage of the plurality of server in the server cluster “A”, “B”, “C”, and “D” may be managed through selection of which servers are referenced in the partial service maps, thereby load balancing the server cluster.

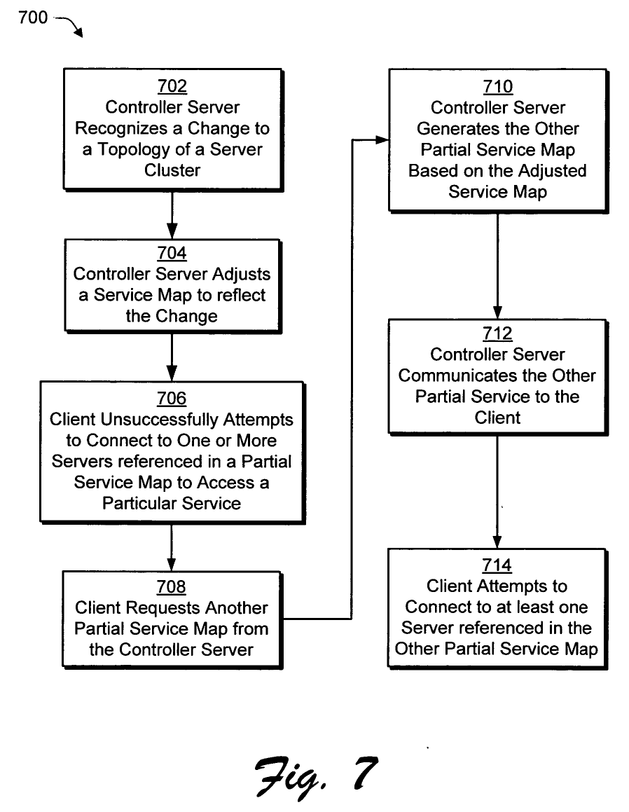

Additionally, through the use of partial service maps, reconfiguration of the servers in the server cluster may be accomplished efficiently. For example, due to the use of a partial service map, changes to the topology of the server cluster do not have to be propagated to each client because each of the clients are provided with a partial service map that describes a portion of the topology. Further, in an implementation, these changes may be “realized” by the clients through use of the failover functionality. For instance, if a change in the topology resulted in unavailability of a particular server, the client may query the server cluster for another partial service map that reflects the updated topology. Thus, the changes to the topology may be “passively” propagated to the clients that are affected by the changes, further discussion of which may be found in relation to FIG. 7.

### Exemplary Environment

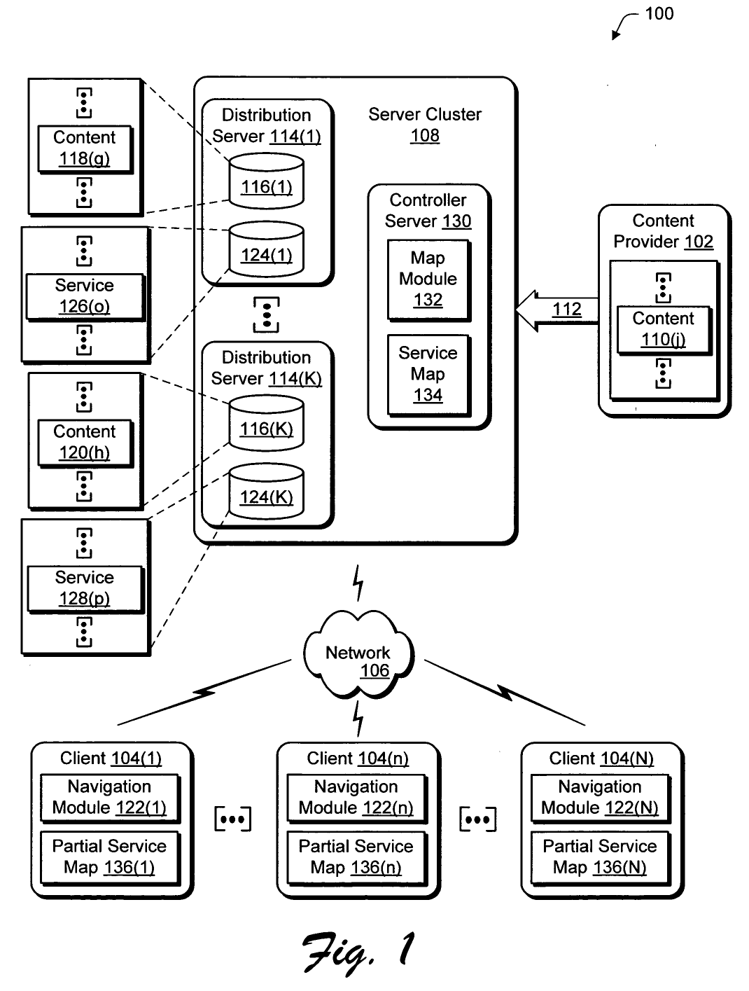

FIG. 1 is an illustration of an environment 100 in an exemplary implementation in which a content provider 102 is configured to provide content to a plurality of clients 104(1), . . . , 104(n), . . . , 104(N) over a network 106 by utilizing a server cluster 108. The clients 104(1)-104(N) may be configured in a variety of ways. For example, one or more of the clients 104(1)-104(N) may be configured as a computer that is capable of communicating over a network 106, such as a desktop computer, a mobile station, an entertainment appliance, a game console, a set-top box communicatively coupled to a display device, a wireless phone, and so forth. The clients 104(1)-104(N) may range from full resource devices with substantial memory and processor resources (e.g., personal computers, television recorders equipped with hard disk) to low-resource devices with limited memory and/or processing resources (e.g., traditional set-top boxes). The clients 104(1)-104(N) may also relate to a person and/or entity that operate the client. In other words, clients 104(1)-104(N) may describe logical clients that include a user and/or a machine. The network 106 is illustrated as the Internet, and may include a variety of other wide area networks (WANs), such as an intranet, a wired or wireless telephone network, a satellite network, a cable network, a digital subscriber line (DSL) network, a broadcast network with a backchannel to provide two-way communication, and so forth.

The content provider 102 includes a plurality of content 110(j), where “j” can be any integer from one to “J”, for communication over a network 112 to the server cluster 108. The network 112 may be the same as or different from network 106. For example, network 112 may be a configured as a dedicated connection between the content provider 102 and the server cluster 108 while network 106 may be configured as the Internet, both networks 106, 112 may be configured as the Internet, and so on.

The content 110(j), when received at the server cluster 108, is stored for distribution by the server cluster 108 via a plurality of distribution servers 114(1)-114(K). Each of the distribution servers 114(1)-114(K) is illustrated as including a respective storage device 116(1)-116(K) for storing the content 110(j) to indicate that the distribution servers 114(1)-114(K) have access to the respective storage devices 116(1)-116(K). In another implementation, each of the storage devices 116(1)-116(K) is configured as a “stand-alone” unit that is accessible by the one or more of the distribution servers 114(1)-114(K).

The plurality of distribution servers 114(1)-114(K) in this implementation are configured to distribute content received from the content provider 102 to the plurality of clients 104(1)-104(N) over the network 106. For instance, the distribution server 114(1) may store a portion of the content 110(j) from the content provider 102 on the storage device 116(1) as content 118(g), where “g” can be any integer from one to “G”. Likewise, distribution server 114(K) may store another portion of the content 110(j) on the storage device 116(K) as content 120(h), where “h” can be any integer from one to “H”. The pluralities of content 118(g), 120(h) may also include content obtained from a wide variety of other sources, such as through execution of applications (e.g., games, remote application processing, and so on) locally on the distribution servers 114(1)-114(K). Thus, the pluralities of content 118(g), 120(h) may be configured in a variety of ways, such as television programming, video-on-demand (VOD), one or more results of remote application processing, and so on. The pluralities of content 118(g), 120(h) may then be communicated over the network 106 for receipt by the plurality of clients 104(1)-104(N).

Each of the clients 104(1)-104(N) may be configured in a variety of ways to receive the content 118(g), 120(h) from over the network 106, such as a set-top box, a broadcast-enabled computer, a wireless phone, and so on as previously described. In an implementation, each of the clients 104(1)-104(N) includes hardware and software to transport and decrypt content 118(g), 120(h) received from the distribution servers 114(1)-114(K) for rendering on an output device, such as by a display device, speakers, and so forth. For example, each of the clients 104(1)-104(N) may include a respective navigation module 122(1)-122(N) that is executable thereon to control content playback on the respective client 104(1)-104(N).

The navigation modules 122(1)-122(N), for instance, may be executed to request content 118(g), 120(h) from the distribution servers 114(1)-114(K) for rendering by the respective clients 104(1)-104(N). For example, when playback of the content 120(h) is requested, the navigation module 122(1) is executed on the client 104(1) to retrieve the content 120(h) from distribution server 114(K). The navigation module 122(1) may also restore the content 120(h) to the original encoded format. For example, when the content 120(h) is recorded on the storage device 116(K) from the content provider 102, the content 120(h) may be compressed. Therefore, when the navigation module 122(1) retrieves the content 120(h), the content 120(h) is decompressed for rendering, such as by a display device.

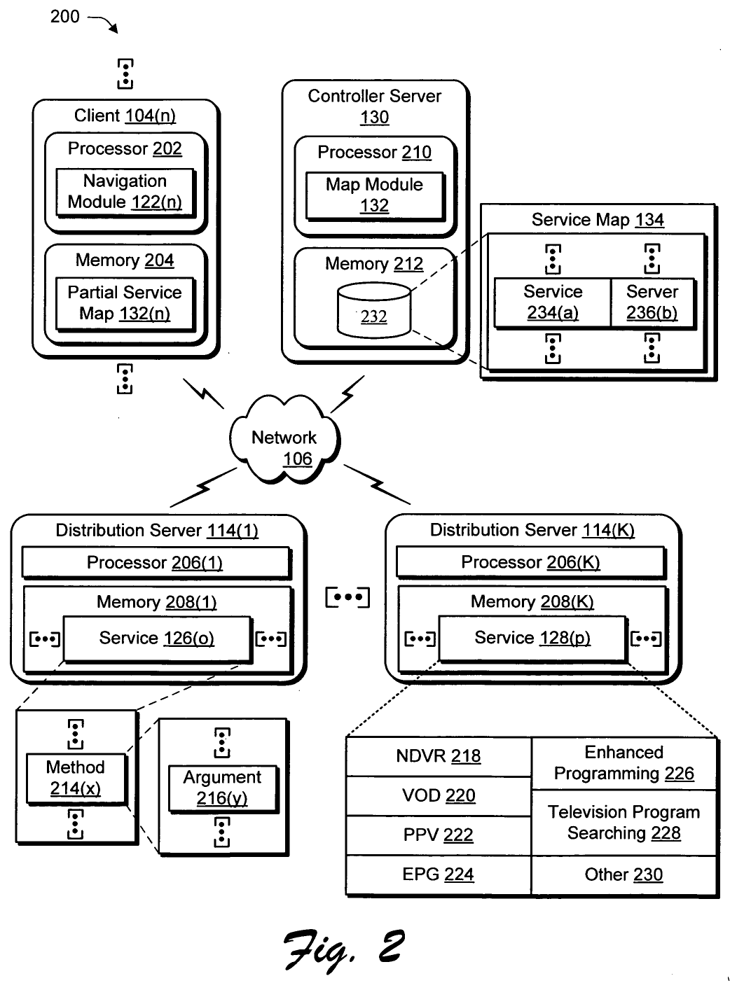

The navigation modules 122(1)-122(N) may be executed on the respective clients 104(1)-104(N) to provide access to a wide range of additional television functionality. For example, each of the distribution servers 114(1)-114(K) may include a respective database 124(1)-124(K) of respective services 126(o), 128(p), where “o” and “p” can be any integer from one to “O” and “P”, respectively. One or more of the services 126(o), 128(p) are executable to provide television services, such as a streaming television program. For example, streaming a television program may be a complex undertaking in that television data being streamed is also being constantly updated, it may take a certain amount of time to receive enough television data to stream the television data to a client, and it make take an additional amount of time at the client to begin output of the streamed television program. Therefore, the addition or removal of a distribution server 114(1)-114(K) from a server cluster that streams data, such as television data, may result in additional complications in starting and transferring the streaming data. Further examples of television services 126(o), 128(p) are described in greater detail in relation to FIG. 2. Although each of the plurality of distribution servers 114(1)-114(K) is illustrated as providing content and services, the distribution servers 114(1)-114(K) may be configured in a variety of ways. For example, one or more of the distribution servers 114(1)-114(K) may be configured to provide services without providing content.

A controller server 130 is also included in the server cluster 108 and is communicatively coupled to the network 106. Although a single controller server 130 is shown, a plurality of controller servers may be utilized in the environment 100, and in particular the server cluster 108. Additionally, although the controller server 130 is illustrated as separate from the distribution servers 114(1)-114(K), the controller server 130 may also provide content and/or services as previously described and therefore function as a distribution server.

The controller server 130 includes a map module 132 that is executable thereon to generate and maintain a service map 134 of each of the services 126(o), 128(p) that is available from the respective distribution servers 114(1)-114(K). In other words, the service map 134 describes which service is available from which distribution server in the server cluster 108. The service map 134 may be generated in a variety of ways, such as by the controller server 130 during configuration of the other servers 114(1)-114(K), received as an input from a user that describes the distribution of services that was selected by the user, and so on. The service map 134 may be configured in a variety of ways, such as a database, table, and so on, which provides the ability to locate which of the distribution servers 114(1)-114(K) carry particular services. However, as previously described, a vast number of services may be available from the server cluster 108. For instance, the number of services may be such that each distribution server 114(1)-114(K) does not carry (i.e., provide) each service that is available form the server cluster 108. In other words, each of the services 126(o) of distribution server 114(1) does not match each of the services 128(p) of distribution server 114(K). Because of the vastness of the number of services, the service map 134 may become quite large such that when communicated to the clients 104(1)-104(N) it may consume an inordinate amount of network and client resources.

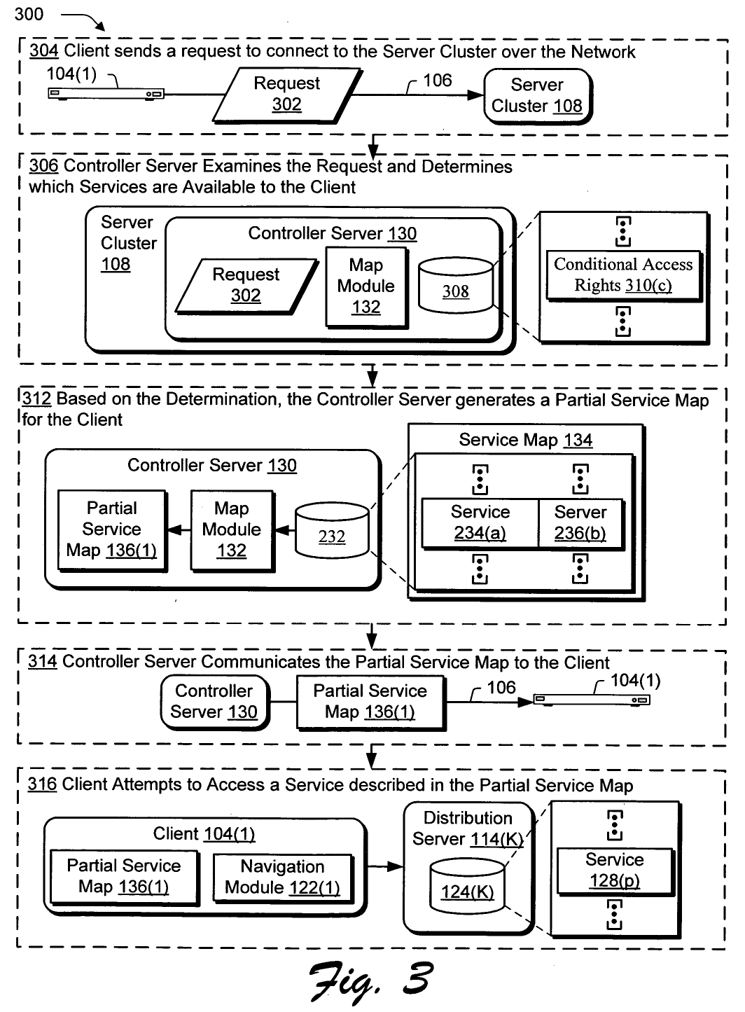

Therefore, to provide efficient utilization of network, hardware and software resources of the network 106 and clients 104(1)-104(N), the controller server 130 executes the map module 132 to generate a partial service map 136(1)-136(N) for each of the respective clients 104(1)-104(N) to locate and access the services 126(o), 128(p). Each of the partial service maps 136(1)-136(N) describes a subset of the distribution servers 114(1)-114(K) which are assigned to provide the different services 126(o), 128(p). The clients 104(1)-104(N) may then select from the subset of servers which are described by the respective partial service maps 136(1)-136(N) a particular one of the plurality of distribution servers 114(1)-114(K) which provide the desired service. If one of the clients 104(1)-104(N) desire access to a service which is not available via the respective partial service map 136(1)-136(N), such as due to unavailability of the described distribution server 114(1)-114(K), the map module 132 may provide an update to allow the client to access (e.g., tune to) a different server. This architecture minimizes the storage requirements on the clients 104(1)-104(N) and the network traffic required to update the partial service maps, as maps may be updated on an “as needed” basis. Additionally, the client may specify a subset of services that it is interested in, and the controller server 130 may create a corresponding partial service map which references just those services. Thus, the plurality of partial service maps 136(1)-136(N) may be configured in a variety of ways to provide desired functionality, such as failover and load balancing, further discussion of which may be found beginning in relation to FIG. 3.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of the failover and load balancing strategies described below are platform-independent, meaning that the failover and load balancing strategies may be implemented on a variety of commercial computing platforms having a variety of processors.

FIG. 2 is an illustration of a system 200 in an exemplary implementation that includes the plurality of clients 104(n), the controller server 130, and plurality of distribution servers 114(1)-114(K) and respective services 126(o), 128(p) of FIG. 1. Each of the clients 104(n), controller server 130, and distribution servers 114(1)-114(K) are illustrated as including a processor and memory. For example, the navigation module 122(N) is illustrated as being executed on a processor 202 and is storable in memory 204 of the client 104(n). Each of the distribution servers 114(1)-114(K) are also illustrated as including a respective processor 206(1)-206(K) and memory 208(1)-208(K). Likewise, the controller server 130 is illustrated as executing the map module 132 on the processor 210, which is also storable in memory 212.

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 204, 208(1)-208(K), 212 is shown for each of the respective devices, a wide variety of types and combinations of memory may be employed, such as random access memory (RAM), hard disk memory, removable medium memory, and so forth.

Services 126(o), 128(p) extend the functionality of the Internet by providing a basis for software to connect to other software applications. Services 126(o), 128(p) provide computer functionality in a way that may be used by a diverse range of devices, using different networks and protocols, to provide various functions. A service typically provides a specific element of functionality to service a specific request, such as data relating to a topic, data processing, and the like. For instance, a service may perform a mathematical function, return requested data, and the like. In additional implementations, the service provides multiple elements of functionality, such as EPG data and television program searching.

Services 126(o), 128(p) provide application logic that is programmatically available. For example, service 126(o) may be called by navigation module 122(1), which may then receive data in a format that may be accessed and processed by the navigation module 122(1). By providing application logic that is programmatically available, services 126(o), 128(p) may be accessed in a variety of ways. A service, for instance, may be accessed by an application implemented internally within a computer, by a computer over an intranet, by a computer over the Internet, and the like. Additionally, a service may use open Internet standards so that it may be accessed by a wide range of users in a seamless manner. For instance, an application running locally on a user's computer may access the service using open Internet standards directly.

Each service 126(o) supports one or more methods 214(x), where “x” can be any integer from one to “X”. Although in the illustrated example of FIG. 2 service 126(o) is shown as supporting a plurality of methods 214(x), a service may also support a single method. Additionally, each method 214(x) may support one or more arguments 216(y), where “y” can be any integer from one to “Y”. Distribution server 114(1), for instance, may provide a service 126(o) having method 214(x) for locating a particular television program. To find the particular television program, a user may specify a name of the television program, which is supplied as an argument for the method 214(x) of a service 126(o). For example, the distribution server 114(1) has a method 214(x) configured as “query <television_Program>” which accepts a user-supplied argument 216(y) “football” to specify a particular television program.

The services 126(o), 128(p) may be configured to provide a variety of television services. Service 128(p), for example, may be configured to provide network digital video recorder (NDVR) services 218, video-on-demand (VOD) 220 services, pay-per-view (PPV) 222 services, electronic programming guide (EPG) services 224, enhanced programming 226, television program searching 228, and other 230 television services, such as digital rights management (DRM), t-commerce (i.e., “television” commerce), and so on. Each of the exemplary television services will be described in the following discussion.

Network Digital Video Recorder (NDVR) 218 Services

As previously described, the client 104(n) may be configured in a variety of ways, such as a DVR which includes the storage device to record content received from the network 106 for output to and rendering by a display device. The navigation module 122(n) may be utilized by the client 104(n) to control content playback on the client 104(n), such as through the use of one or more “trick modes”. The trick modes may provide non-linear playback of the content. Non-linear playback may include time shifting the playback of the content, such as pause, rewind, fast forward, slow motion playback, and the like.

The distribution server 114(K) may also provide similar functionality to the client 104(n) over the network 106 by providing NDVR 218 services. For example, the navigation module 122(1), when executed, may form a request for communication to the distribution server 114(K) over the network 106 to record a particular television program. The service 128(p), upon receipt of the request, records the particular television program. When the client 104(n) wants to watch the recorded television program, the television program may be streamed from the distribution server 114(K) to the client 104(n) over the network 106.

Video-on-Demand (VOD) 220 Services

VOD 220 services enable the client 104(n) to view television content when desired, instead of at a predetermined point-in-time. VOD 220 services may also provide trick modes to the client 104(n), such as to enable the client 104(n) to pause, fast forward, rewind, and provide slow motion playback in a manner similar to the techniques previously described for DVR and NDVR. The VOD 220 service, for instance, may stream content stored at the distribution server 114(K) to the client 104(n) over the network 106. The client 104(n) may initiate one or more trick modes through execution of the navigation module 122(1). The trick modes in this instance are used to control the streaming of the content to client 104(n). Thus, a user of the client 104(n) may pause, fast-forward, and rewind the playback of the content at the client like the DVR example through communication with the VOD 220 service.

Pay-Per-View (PPV) 222 Services

PPV 222 services are similar to VOD 220 services. PPV 222 services, however, generally provide television content at a predetermined point-in-time. Therefore, the client 104(n) generally purchases rights to access content that is broadcast at predetermined points-in-time. PPV 222 services may also include authentication of the client 104(n) to access the services, such as to collect identification and billing information of the client 104(n).

Electronic Program Guide (EPG) 224 Services

EPG 224 services enable the client 104(n) to navigate through television program listings and descriptions. For example, the EPG 224 services may supply a listing of television programs for broadcast during selected periods of time. The listing may also include television programs that are available for access, such as VOD 220 services, PPV 222 services, and so on.

Enhanced Programming 226 Services

Enhanced programming 226 services are generally utilized to provide informative content that is related to television content that is being rendered by a display device. For example, enhanced programming 226 services may be utilized to provide content that is integrated with a broadcast of a television program to promote an interactive experience, such as a play-along game show, fantasy sports, and so on.

Television Program Searching 228 Services

Television program searching 228 services may be utilized by the client 104(n) to locate desired television programming. For example, the television programming searching 228 services may be utilized in conjunction with the EPG 224 services to navigate to a particular television program of interest by supplying data for one or more searchable fields. Examples of searchable fields include program title, actor, genre, duration, broadcast time, and so on.

Other 230 Services

Although a variety of television services have been described, other 230 services may also be provided, such as digital rights management (DRM) services, t-commerce, and so forth. DRM services may be utilized to control access to content. For example, television programming may be encrypted utilizing one or more encryption keys. Therefore, to access the content, the client 104(n) forms one or more requests for accessing the content that are communicated to the distribution server 114(K). The distribution server 114(K), in response to the requests, may then determine whether the client 104(n) has rights to access the content, obtain billing information, and so on. If the client 104(n) has rights to access the content, the distribution server 114(K) may communicate a license that includes access rules that specify the rights of the client 104(n) for accessing the content and one or more decryption keys for decrypting the content. Thus, the client 104(n) may access the television programming according to the access rules specified in the license provided through execution of the DRM services.

Television commerce, in what may be referred to as “t-commerce”, enables users of the client 104(n) to purchase goods and/or services in a manner similar to electronic commerce or “e-commerce”. For example, a user of the client 104(n) may utilize a remote control, instead of a keyboard, to purchase an item that is displayed on a display device. Such a service has proven appeal in certain demographics where users do not feel comfortable with computers but still wish to avail themselves of the convenience of shopping from home.

Services may also be utilized to stream content 118(g), 120(h) of FIG. 1 to the clients 104(n). For example, the content 118(g), 120(h) may include television content, radio content, and so on, that is streamed to the client 104(n) when requested. For instance, service 126(o) may process requests received from the client 104(n) to determine if the client 104(n) has subscribed to the particular content 118(g), and if so, stream the content 118(g) to the client 104(n).

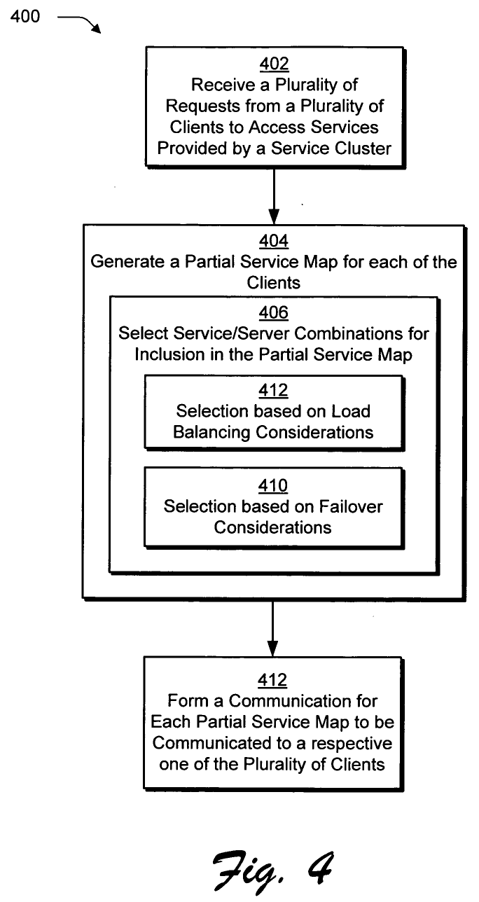

To enable the client 104(n) to locate the services 126(o), 128(p), the controller server 130 may execute the map module 132 on the processor 210 to generate a partial service map 136(n) for each client 104(n). For example, the map module 132, when executed, may access a database 232 (which is illustrated as included in the memory 212) that provides the service map 134 to derive a subset of the services 126(o), 128(p) which are available from each of the plurality of distribution servers 114(1)-114(K). For instance, the map module 132 may examine the service map 134, which is illustrated as a table that includes a plurality of service 234(a) references (where “a” can be any integer from one to “A”) and corresponding server 236(b) references (where “b” can be any integer from one to “B”). By examining the service map 134, the map module 132 may determine which distribution server provides which service, and select a subset of the servers for each service to form the partial service map 136(n). In this way, the partial service map 136(n) may efficiently describe the services which are available to the client 104(n) and the servers from which the services may be obtained such that the client 104(n) may locate the desired services without storing and examining the entire service map 134. The map module 132 may generate the partial service map 136(n) based on a wide variety of considerations, such as to provide load balancing and fail over, further discussion of which may be found in relation to FIG. 4.

Exemplary Procedures

The following discussion describes failover and load balancing techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks.

FIG. 3 is a flow diagram depicting a procedure 300 in an exemplary implementation in which a partial service map is generated for a client based on the services that are available to the client. A client 104(1) first sends a request 302 to connect to the server cluster 108 over the network 106 (block 304). The request 302, for example, may specify a particular service that is provided by the server cluster, request general access to each service in the server cluster 108, and so on.

The request 302 is directed to the controller server 130, which examines the request 302 and determines which services are available to the client 104(1) (block 306). The controller server 130, for instance, may execute the map module 132 as previously described to perform the examining and the determining. For example, the map module 132, when executed, may identify the particular client 104(1) from the request 302. The map module 132 may then examine a database 308 that describes a plurality of conditional access rights 310(c), where “c” can be any integer from one to “C”. The conditional access rights 310(c) specify which services the client 104(1) may access, such as through a subscription, payment of a fee, free access, and so on.

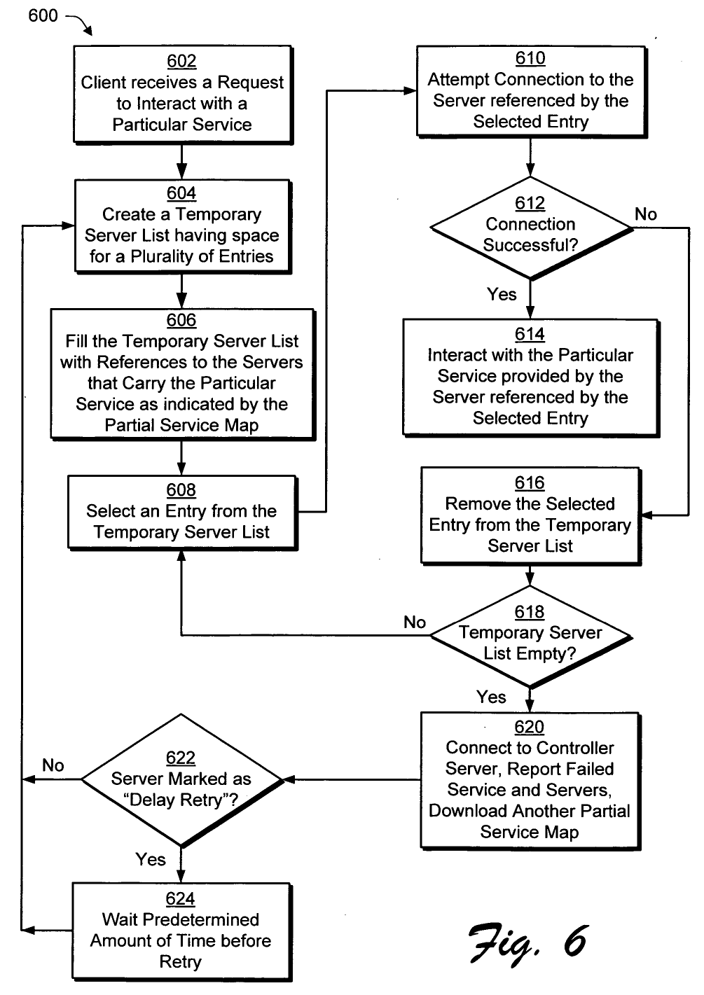

Based on the determination, the controller server 130 generates a partial service map 136(1) for the client 104(1) (block 312). As illustrated, the controller server 130 may execute the map module 132 to examine a database 232 that describes a complete service map 134 of service 134(a)/server 236(b) combinations. Based on the examination, the map module 132 may select at least two servers which provide a particular service to which the client has access as previously determined (block 306). The selected servers and corresponding services may then be arranged to form the partial service map 136(1) for the client 104(1). In this example, the partial service map 136(1) references at least two different servers for each service that the client is permitted to access. Thus, the client is provided with failover functionality through the referenced alternative servers for each service, thereby protecting against unavailability of one of the servers. In another example, if two servers are not available for carrying an individual service, the partial service map may contain a reference to a single source (e.g., server) of the individual service. Further discussion of failover functionality may be found in relation to FIGS. 4 and 6.

The controller server 130 may then form a communication for communicating the partial service map 136(1) to the client 104(1) (block 314) and send the communication to the client 104(1). Upon receipt of the partial service map 136(1), the client 104(1) executes the navigation module 122(1) which inspects the partial service map 136(1) to select a particular server (e.g., distribution server 114(K)) for accessing a desired service 138(p) (block 316). Selecting may be performed in a variety of ways. In a first example, the client 104(1), through execution of the navigation module), randomly selects a server from the partial service map 136(1) which provides the desired service. In another example, the partial service map 136(1) defines an order the client 104(1) is to use to attempt access. Both examples may be utilized for load balancing of processing performed by the distribution servers 114(1)-114(K), further discussion of which may be found in relation to the following figure.

FIG. 4 is a flow diagram depicting a procedure 400 in an exemplary implementation in which a plurality of partial service maps are provided to a plurality of clients which request access to services in a service cluster. A plurality of requests is received by a service cluster from a plurality of clients (block 402). In response to the requests, a partial service map is generated for each of the clients that requested access to a service (block 404). A variety of techniques may be employed to generate each partial service map.

A map module, for instance, may be executed to select service/server combinations for inclusion in the partial service map (block 406). Each service/server combination may reference a particular service and a server which provides that service. The service/server combinations may be selected based on a variety of considerations.

For example, the map module, when executed, may select service/server combinations based on load balancing considerations (block 408). For instance, the combinations referenced in the partial service map may be based on previous combinations that were referenced in other partial service map(s), based on current load information obtained by the controller server 130 of FIG. 1 from the distribution servers 114(1)-114(K), and so on. In this way, the map module may distribute the access attempts by the clients, and therefore the processing performed by the servers in providing the services. In a first implementation, the partial service map defines an order in which the client is to communicate with the servers to access the services. Thus, the map module in this instance has detailed “knowledge” of which servers particular clients may utilize to attempt to access particular services. In another implementation, the clients randomly pick a server from the partial service list. Even in this instance, the map module is still “aware” of which servers the client may attempt to access to interact with particular services. Thus, in both these implementations the partial service maps may be populated by the map module to “passively” load balance the server cluster.

In another example, the map module, when executed, may select service/server combinations based on failover considerations (block 410). For example, the map module may have previously provided a particular client with a partial service map. However, each server referenced in the partial service map that provides a particular service may have been unavailable to the client. Therefore, the client may request another partial service map and notify the map module of the unavailability of the servers. In response to the request, the other partial service map may be populated with other servers which provide the particular service. In an implementation, the map module may also employ heuristics to determine which servers are most likely to be accessible by which clients, and populate the partial service map such that at least one of these “most likely accessible” servers are provided for each service. Further discussion of partial server maps and server unavailability may be found in relation to FIG. 6.

After the partial service map is generated (block 404), the map module may be executed to form and send a communication that contains the partial service map to a respective one of the plurality of clients (block 412). Thus, each client that sent a request may be provided with a partial service map that reduces the amount of data that needs to be transferred over the network and may be configured based on a wide variety of considerations to provide additional functionality.

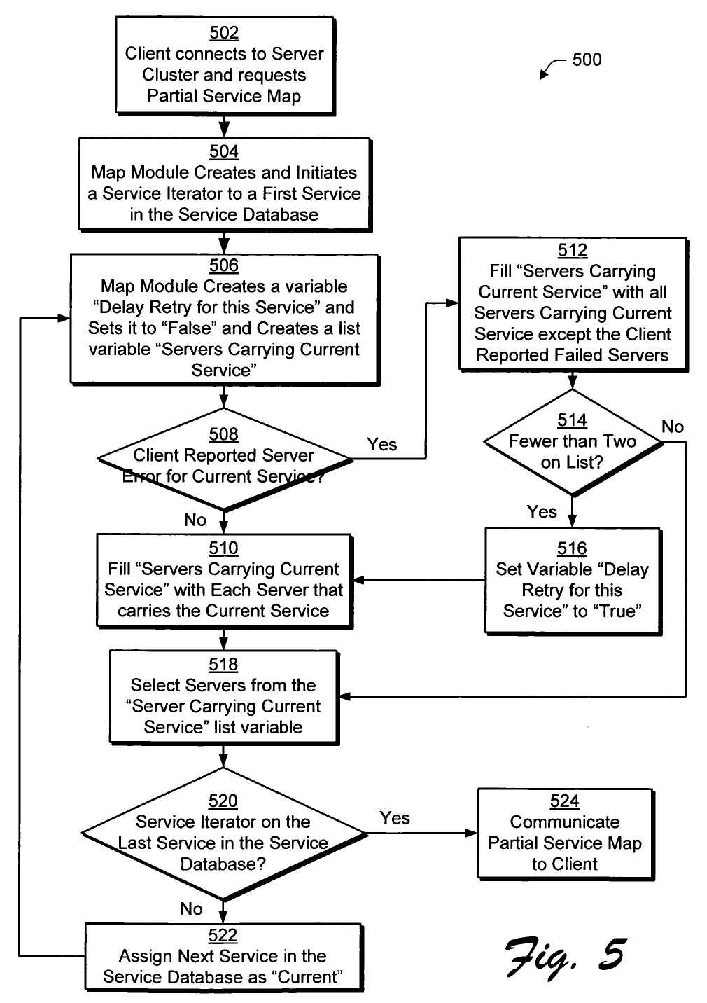

FIG. 5 is a flow diagram depicting a procedure 500 in an exemplary implementation in which selection of service/server combinations is described for inclusion in a map to be communicated to a client. A client connects to a server cluster and requests a service map (block 502). In response to the request, a map module is executed to create and initiate a service iterator to a first service in a service database (block 504). For example, the service iterator may select a service 234(a) from the database 232 of FIG. 2.

The map module is executed to create a variable “delay retry for this service” and sets it to “false” and creates a list variable “servers carrying current service” (block 506). A determination is then made as to whether the client reported an error for the current service (decision block 508). If not, the “servers carrying current service” list variable is filled with each server that carries the current service (block 510). If so, the “servers carrying current service” list variable is filled with all servers carrying the current service, except the client reported failed servers (block 512). In other words, the server which is indicated as failed by the client is not included in the list variable.

A determination is then made as to whether there are fewer than two servers on the “servers carrying current service” list variable (decision block 514). If there are fewer than two servers (decision block 514), the variable “delay retry for this service” is set to “true” (block 516) and the “servers carrying current service” list variable is filled with each server that carries the current service (block 510). Thus, in this implementation, if there is not an alternative server, the map module adds a currently inaccessible server in the “servers carrying current service” list variable and sets a flag such that an amount of time elapses before trying to access the unavailable server. The amount of time may be determined in a variety of ways, such as set to a predetermined amount, randomly determined by the client, and so on. Thus, a retry may be utilized in case the server was temporarily unavailable, thereby still providing an alternative server from which the service may be obtained. Additionally, the “delay retry for this service” may protect the client from becoming mired in a “tight loop” in which constant retries are performed when all servers carrying a particular service are unavailable. For instance, the “delay retry for this service” variable may be set for a predetermined amount of time that is sufficient for the server to be rebooted, which may result in the availability of the rebooted server to the client.

If there are at least two servers on the list (decision block 514) or once the “servers carrying current service” list variable is filled (block 510), the map module is executed to select servers from the “servers carrying current service” list variable (block 518). As previously described in relation to FIG. 4, the selection may be performed based on a wide variety of considerations, such as load balancing considerations, failover considerations, and so on. For example, the selection may be based on client “location” such that the servers that may provide more efficient communication of streaming content to the client are selected first.

A determination is then made as to whether the service iterator has processed the last service in the service database (decision block 520). If not, the map module may assign a next service in the service database as “current” (block 522). As before, the map module may again create the variable “delay retry for this service” and set it to “false” and create another “servers carrying current service” list variable (block 506) to process the next service. Once the last service in the service database has been reached (decision block 520), the partial service map is communicated to the client (block 524).

FIG. 6 is a flow diagram depicting a procedure 600 in an exemplary implementation in which the partial service map that was generated in the procedure 500 of FIG. 5 is utilized by a client to access a service utilizing failover techniques. A client receives a request to interact with a particular service (block 602). For instance, a user may utilize an input device (e.g., a keyboard, mouse, remote control, touch screen, and so on) to select the particular service which streams a particular television program to the client. In response to the request, the client creates a temporary server list having space for a plurality of entries (block 604). The temporary server list is then filled with references to the servers that carry the particular service as indicated by the partial service map (block 606) that was previously communicated to the client (block 524, FIG. 5).

A navigation module is then executed to select an entry from the temporary server list (block 608). For example, the partial service map may define an order in which the servers are to be accessed. Therefore, in such an instance the navigation module may select the first such indicated server. In another instance, however, the navigation module randomly selects one of the servers which provide the desired service.

The navigation module is then executed to attempt a connection to the server referenced by the selected entry (block 610). A determination is then made as to whether the connection is successful (decision block 612), and if so, the client interacts with (e.g., accesses) the particular service provided by the selected server which was referenced in the partial service map (block 614).

If the connection is not successful (decision block 612), however, the selected entry is removed from the temporary server list (block 616). A determination is then made as to whether the temporary server list is empty (decision block 618). If not, another entry is selected from the temporary server list (block 608) and a connection attempted (block 610). If the temporary server list is empty (decision block 618), the client connects to the controller server to report the failed service and servers and downloads another partial service map (block 620).

Upon receipt of the other partial service map, a determination is made as to whether a referenced server for the particular service is marked as “delay retry” (decision block 622). If not, a temporary server list is created as before (block 604). If the server is marked for “delay retry” (decision block 622), the client may wait a predetermined amount of time before retrying a connection with the referenced server (block 624). For instance, as previously described in relation to FIG. 5, instances may be encountered in which the server cluster “runs out” of servers that are available to provide the particular service. Therefore, a reference to such a server may be included in the other partial service list and marked such that the client waits the predetermined amount of time before retrying a connection with the server. The predetermined amount of time, for example, may be computed in order to give the server a sufficient amount of time for reboot, which may then result in availability of the server. The predetermined amount of time may be computed in a wide variety of other ways, such as through heuristics, network monitoring of lag times, staggered amounts that are computed by each of the clients to prevent repeated cycles of high loads on the controller server 130 of FIG. 1, and so on.

Thus, in this implementation, the client reports the unavailability of servers to the controller server, thereby providing failover functionality without active monitoring by the controller server itself. Rather, the controller server may “passively” receive reports of unavailability and react accordingly. In another implementation, the controller server may also employ a polling model which “pings” the servers to determine availability.

FIG. 7 is a flow diagram depicting a procedure 700 in an exemplary implementation in which a change to a topology of a server cluster is passively propagated to a plurality of clients that are affected by the change. A controller server recognizes a change to a topology of a server cluster (block 702). For example, the controller server may determine that a server has been added to the server cluster, has been removed from the server cluster, has become unavailable, has its availability restored, and so on. The controller server may recognize the change in a variety of ways, such as by querying (e.g., “pinging” ) each of the plurality of servers, receiving a notification from one or more of the servers regarding the status of a neighboring server, and so on.

In response to the recognizing (block 702), the controller server adjusts a service map to reflect the change (block 704). For example, the controller server 130 of FIG. 1 may update the service map 134 to reflect the addition, removal, and/or availability of the plurality of distribution servers 114(1)-114(K).

Meanwhile, a client unsuccessfully attempts to connect to one or more servers referenced by a partial service map to access a particular service (block 706). For example, before, after, and/or during the recognizing (block 702) and/or adjusting (block 704), the client may attempt to utilize a previous partial service map obtained from the controller server to locate a server that streams a particular television program. However, each server referenced in the partial service map is not available to the client, such as due to the change in the topology of the server cluster. Therefore, the client requests another partial service map from the controller server (block 708).

In response to the request, the controller server generates the other partial service map based on the adjusted service map (block 710). For example, the partial service map may reference servers that are available based on the change to the topology of the server cluster. The controller server may then communicate the other partial service map to the client (block 712) that reflects the changed topology, which may be utilized by the client to attempt to connect to at least one server referenced in the partial service map (block 714) as previously described.

In this implementation, the use of partial service maps and failover functionality may be utilized to communicate changes that occur to a topology of a server cluster to clients that are affected by the change. Thus, the changes to the topology may be “passively” propagated to the clients that are affected by the change without affecting other clients that are not affected by the change.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
receiving a plurality of requests from a plurality of clients, wherein each said request is for accessing a service provided by a plurality of servers arranged in a server cluster; and
generating a partial service map for each said client such that each said partial service map references a subset of the plurality of servers.

2. A method as described in claim 1, wherein one said partial service map references at least one said server that is not referenced in another said partial service map.

3. A method as described in claim 1, wherein the receiving and the generating are performed at a head end.

4. A method as described in claim 1, wherein at least one said service is configured to stream content over a network to one or more said clients.

5. A method as described in claim 1, wherein one or more said services are selected from the group consisting of:
a television program service;
a streamed audio service;
a streamed radio service;
a streamed video service;
a video-on-demand (VOD) service;
an electronic programming guide (EPG) service;
a pay-per-view (PPV) service;
a network digital video recorder (NDVR) service;
an enhanced television programming service;
an enhanced streamed video service;
an enhanced streamed audio service;
a television program searching service;
a digital rights management (DRM) service; and
a television-commerce (t-commerce) service.

6. A method as described in claim 1, wherein each said partial service map is generated to balance use of the plurality of servers by the plurality of clients to access the plurality of services

7. A method as described in claim 1, further comprising generating another partial service map for one said client when each said server which provides a particular said service that is referenced in a previous said partial service map that was obtained by the one said client is unavailable.

8. A method as described in claim 7, wherein the generating of the other partial service map is performed in response to a request received from the one said client.

9. A method as described in claim 7, wherein:
the other partial service map references at least one said server that was indicated by the one said client as unavailable; and
an amount of time is set for retrying access to the at least one said server.

10. A method as described in claim 1, further comprising forming:
a first communication for communicating the one said partial service map to one said client; and
a second communication for communicating the other said partial service map to another said client.

11. One or more computer readable media comprising computer executable instructions that, when executed by a computer, direct the computer to perform the method of claim 1.

12. A method comprising:
recognizing a change to a topology of a server cluster, wherein the server cluster includes a plurality of servers configured to provide a plurality of services; and
in response to a request from one or more clients affected by the change, generating a partial service map for communication to each said client, wherein each said partial service map reflects the changed topology of the server cluster.

13. A method as described in claim 12, wherein at least one said request is communicated from a corresponding said client that includes a pervious partial service map that references at least one said server that is no longer available due to the change to the topology.

14. A method as described in claim 12, wherein the recognizing and the generating are performed at a head end.

15. A method as described in claim 12, wherein at least one said service is configured to stream content over a network to one or more said clients.

16. A method as described in claim 12, wherein one or more said services are selected from the group consisting of:
a television program service;
a streamed audio service;
a streamed radio service;
a streamed video service;
a video-on-demand (VOD) service;
an electronic programming guide (EPG) service;
a pay-per-view (PPV) service;
a network digital video recorder (NDVR) service;
an enhanced television programming service;
an enhanced streamed video service;
an enhanced streamed audio service;
a television program searching service;
a digital rights management (DRM) service; and
a television-commerce (t-commerce) service.

17. A method comprising:
selecting at least one server that provides a particular service from a map that references a plurality of said servers, each providing the particular service;
attempting to access the particular service provided by one or more said servers; and
when each said server which provides the particular service is unavailable for access, notifying a controller server of the unavailability of each said server.

18. A method as described in claim 17, wherein:
the selecting, the attempting, and the notifying are performed by a client that is communicatively coupled to a controller server over a network; and
the controller server is configured to generate the map.

19. A method as described in claim 17, wherein at least one said service is configured to stream content over a network to one or more said clients.

20. A method as described in claim 17, wherein the service is selected from the group consisting of:
a television program service;
a streamed audio service;
a streamed radio service;
a streamed video service;
a video-on-demand (VOD) service;
an electronic programming guide (EPG) service;
a pay-per-view (PPV) service;
a network digital video recorder (NDVR) service;
an enhanced television programming service;
an enhanced streamed video service;
an enhanced streamed audio service;
a television program searching service;
a digital rights management (DRM) service; and
a television-commerce (t-commerce) service.

21. A method as described in claim 17, wherein the map is generated by the controller server to balance use of the plurality of said servers by a plurality of clients.

22. A method as described in claim 17, further comprising obtaining another map from the controller server over a network when each said server which provides the particular service is unavailable, wherein the other map references another server that provides the particular service.

23. A method as described in claim 22, wherein the other map is generated by the controller server in response to a request received from a client that performs the attempting.

24. A method as described in claim 22, wherein:
the other map references at least one said server to which access to the particular service was attempted; and
an amount of time is set for retrying access to the at least one said server.

25. One or more computer readable media comprising computer executable instructions that, when executed by a computer, direct the computer to perform the method of claim 17.

26. A method comprising:
receiving a plurality of requests from a plurality of clients, wherein each said request is for accessing one or more of a plurality of services provided by a plurality of servers arranged in a server cluster; and
generating a partial service map for each said client, wherein each said partial service map is generated to balance access by the plurality of clients to the plurality of servers to utilize the plurality of services.

27. A method as described in claim 26, wherein the receiving and the generating are performed at a head end.

28. A method as described in claim 26, wherein at least one said service is configured to stream content over a network to one or more said clients.

29. A method as described in claim 26, wherein one or more said services are selected from the group consisting of:
a television program service;
a streamed audio service;
a streamed radio service;
a streamed video service;
a video-on-demand (VOD) service;
an electronic programming guide (EPG) service;
a pay-per-view (PPV) service;
a network digital video recorder (NDVR) service;
an enhanced television programming service;
an enhanced streamed video service;
an enhanced streamed audio service;
a television program searching service;
a digital rights management (DRM) service; and
a television-commerce (t-commerce) service.

30. A method as described in claim 26, further comprising generating another partial service map for one said client when each said server which provides a particular said service that is referenced in a previous said partial service map that was obtained by the one said client is unavailable.

31. A method as described in claim 30, wherein the generating of the other partial service map is performed in response to a request received from the one said client.

32. A method as described in claim 30, wherein:
the other partial service map references at least one said server that was indicated by the one said client as unavailable; and
an amount of time is set for retrying access to the at least one said server.

33. One or more computer readable media comprising computer executable instructions that, when executed by a computer, direct the computer to perform the method of claim 26.

34. A controller server comprising:
a processor; and
memory configured to maintain
a database describing a plurality of services that are available via a plurality of servers arranged to form a cluster; and
one or more modules that are executable on the processor to generate a partial service map from the database for a client that requests access to a particular said service, wherein the partial service map references at least two said servers that provide the particular said service but does not reference another said server that provides the particular said service.

35. A controller server as described in claim 34, wherein the partial service map is generated to load balance use of the plurality of services by a plurality of said clients.

36. A controller server as described in claim 34, wherein at least one said service is configured to stream content over a network to the client.

37. A controller server as described in claim 34, wherein one or more said services are selected from the group consisting of:
a television program service;
a streamed audio service;
a streamed radio service;
a streamed video service;
a video-on-demand (VOD) service;
an electronic programming guide (EPG) service;
a pay-per-view (PPV) service;
a network digital video recorder (NDVR) service;
an enhanced television programming service;
an enhanced streamed video service;
an enhanced streamed audio service;
a television program searching service;
a digital rights management (DRM) service; and
a television-commerce (t-commerce) service.

38. A controller server as described in claim 34, wherein the one or more modules are further executable to generate another partial service map for the client when each said server which provides a particular said service that is referenced in a previous said partial service map that was obtained by the client is unavailable.

39. A controller server as described in claim 38, wherein the other partial service map is generated in response to a request received from the client.

40. A controller server as described in claim 38, wherein:
the other partial service map references at least one said server that was indicated by the client as unavailable; and
an amount of time is set in the other partial service map for retrying access to the at least one said server.

41. A server cluster comprising a plurality of servers that are configured for being communicatively coupled to a network, wherein:
at least two said servers are configured to provide a plurality of services; and
one or more said servers are configured to generate a partial service map for each of a plurality of clients to load balance use of the plurality of services by the plurality of clients.

42. A system as described in claim 41, wherein each said partial service map references service/server combinations for locating particular said services that are provided by the at least two said servers.

43. A system as described in claim 41, wherein each said partial service map defines an order for a respective said client to attempt access to each said server referenced by the partial service map.

44. A system as described in claim 41, wherein at least one said partial service map is utilized by a respective said client to select at least one said server which provides the particular service at random from the at least one partial service map.

45. A system as described in claim 41, wherein at least one said service is configured to stream content over a network to one or more said clients.

46. A system as described in claim 41, wherein one or more said services are selected from the group consisting of:
a television program service;
a streamed audio service;
a streamed radio service;
a streamed video service;
a video-on-demand (VOD) service;
an electronic programming guide (EPG) service;
a pay-per-view (PPV) service;
a network digital video recorder (NDVR) service;
an enhanced television programming service;
an enhanced streamed video service;
an enhanced streamed audio service;
a television program searching service;
a digital rights management (DRM) service; and
a television-commerce (t-commerce) service.
